(19) United States
(12) Patent Application Publication
(10) Pub. No.: US 2007/0042246 A1
(43) Pub. Date: Feb. 22, 2007

(54) Fuel cell system, power generation method of fuel cell system, and electric device

(76) Inventors: Eigo Kubota, Tokyo (JP); Chiaki Kanai, Kanagawa (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 10/550,841

(22) PCT Filed: May 28, 2004
(86) PCT No.: PCT/JP04/07782

§ 371 Date: Jun. 5, 2006

(30) Foreign Application Priority Data
Jun. 5, 2003 (JP) 2003-160850

(51) Int. Cl. H01M 8/04; H01M 8/06

(52) U.S. Cl. 429/24; 429/26; 429/20; 429/13

(57) ABSTRACT

A fuel cell system is provided in which waste energy hitherto exhausted from a computer (10) can be reduced to improve the power generation efficiency of a fuel cell (27). Heat generated from a CPU (11) is supplied to the fuel cell (27), thereby controlling the temperature of the fuel cell (27). Consequently, a power generation can be performed while the fuel cell (27) is maintained at a temperature suitable for the power generation.

### TECHNICAL FIELD

The present invention relates to a fuel cell system for controlling a temperature by utilizing heat generated from electrical equipment, a method of power generation of the fuel cell system, and electrical equipment. More specifically, the present invention relates to a fuel cell system in which an electrical energy is efficiently used by utilizing heat generated from a source of heat generation and the power generation efficiency of a fuel cell can be improved, a method of power generation of the fuel cell system, and electrical equipment.

### BACKGROUND ART

As various semiconductor devices installed in a computer have higher performance and the size of computers is decreased, the increase in heat generation caused by increasing the output, the density, and the integration of semiconductor devices has become a significantly serious problem. Such heat generated by the heat generation of semiconductor devices is forcibly cooled using, for example, a heat sink or a cooling fan to suppress the increase in the temperature in a computer. Sources of heat generation such as various electronic components that constitute electrical circuits provided in electrical equipment may also be cooled using a cooling unit such as a heat sink or a cooling fan. Suppressing the increase in the temperature of not only electronic apparatuses such as computers but also various kinds of electrical equipment is an important technique in order to drive electrical equipment stably.

Also, recently, the use of a fuel cell as an electric power source for driving the above-described electrical equipment has been studied. In the fuel cell, a power generation is performed by a chemical reaction of hydrogen and oxygen. Since the resulting product is water, the fuel cell has drawn attention as a power generation unit that does not pollute the environment. A technical development for employing the fuel cell as an electric power source for various kinds of electrical equipment has been actively performed.

The heat generated from the above-described electrical equipment is exhausted to the outside of the electrical equipment by forcibly cooling the source of heat generation. This heat is generated by a conversion of an electrical energy to a thermal energy in a ratio proportional to the electric power consumption of semiconductor devices, other electronic components, or the like, which are a source of heat generation. Such electric power consumption is inevitable in the practical use of electrical equipment. The exhausted thermal energy becomes an energy loss that does not contribute to the driving of the electrical equipment.

Furthermore, in order to cool the above-described source of heat generation, an electric power for driving a cooling unit is necessary. The electric power consumption consumed by this cooling unit also becomes an energy loss that is not negligible to the electric power supplied from an electric power source. Consequently, a technique has been desired in which an electric power supplied from an electric power source is efficiently used by utilizing a thermal energy generated from the above-described source of heat generation to achieve the electric power saving of electrical equipment. Furthermore, in addition the technique for realizing the electric power saving of electrical equipment, in particular, a technique for improving the power generation efficiency of a fuel cell has also been desired.

Accordingly, it is an object of the present invention to provide a fuel cell system in which an electrical energy is efficiently used by utilizing heat generated from a source of heat generation and the power generation efficiency of a fuel cell can be improved, a method of power generation of the fuel cell system, and electrical equipment.

### DISCLOSURE OF INVENTION

A fuel cell system according to the present invention includes a fuel cell, and temperature-controlling means that controls the temperature of the fuel cell by performing a heat transfer from a source of heat generation provided in electrical equipment to the fuel cell. According to this fuel cell system, by performing a heat transfer from the source of heat generation to the fuel cell, a thermal energy that is hitherto exhausted can be utilized to reduce an energy loss. Furthermore, the temperature of the fuel cell can be controlled to a temperature suitable for a power generation with the thermal energy of the source of heat generation. Accordingly, the power generation efficiency of the fuel cell can also be improved.

Furthermore, in the fuel cell system according to the present invention, the temperature-controlling means may be a heat-transfer path that transfers a required quantity of heat. For example, the heat-transfer path may be a flow path of a fluid that mediates the heat transfer. Thus, the temperature of the fuel cell can be controlled through the fluid. Furthermore, such a flow path may be disposed so as to be adjacent to a heat sink that receives heat from the source of heat generation. When the flow path is adjacent to the heat sink, the heat can be efficiently transferred to the flow path. In addition, the fluid may be at least one of a fuel fluid and a fluid for oxidation used for a power generation. In this case, the temperature of the at least one of the fuel fluid and the fluid for oxidation can be controlled to a temperature suitable for a reaction for the power generation.

In addition, the fuel cell system according to the present invention may further include a reformer and the temperatures of the reformer and the fuel can also be controlled by the heat transfer with the temperature-controlling means. Thereby, the reforming of the fuel used in the reaction for the power generation of the fuel can be efficiently performed. Furthermore, the fuel cell system according to the present invention may further include a carburetor and the temperatures of the carburetor and the fuel can also be controlled by the heat transfer with the temperature-controlling means. Consequently, the heat from the source of heat generation can be utilized as a thermal energy required for vaporization of the fuel to reduce an energy loss.

The fuel cell system according to the present invention may include heat-exhausting means that exhausts an excessive quantity of heat transferred to the fuel cell. Thereby, the excessive heat can be exhausted from the fuel cell to efficiently perform the temperature control. The heat-exhausting means may be a heat-exhausting path that exhausts the excessive quantity of heat. For example, the heat-exhausting path may be a flow path of a fluid that transfers the excessive quantity of heat. Thus, the temperature of the fluid can be controlled and the temperature of the fuel cell can be efficiently controlled. Furthermore, such a flow path may be disposed so as to be adjacent to a heat sink provided outside of the fuel cell. When the flow path is adjacent to the heat sink, the heat can be efficiently exhausted from the flow path.

In a method of power generation of a fuel cell system according to the present invention, a heat transfer is performed from a source of heat generation provided in electrical equipment to a fuel cell system including a fuel cell, and the temperature of the fuel cell system is controlled by the heat transfer to perform a power generation. According to the method of power generation of a fuel cell system of the present invention, heat is transferred from the source of heat generation to the fuel cell. Consequently, a thermal energy that is hitherto exhausted can be utilized to reduce the energy loss. Furthermore, the temperature of the fuel cell can be controlled to a temperature suitable for the power generation with the thermal energy from the source of heat generation. Accordingly, the power generation efficiency of the fuel cell can also be improved.

Electrical equipment according to the present invention includes a source of heat generation, a casing that houses the source of heat generation, and a fuel cell system including a fuel cell and temperature-controlling means that controls the temperature of the fuel cell by performing a heat transfer from the source of heat generation. The electrical equipment is driven by an electric power supplied from the fuel cell system. According to the electrical equipment of the present invention, a thermal energy of the source of heat generation can be efficiently used and the power generation efficiency of the fuel cell serving as an electric power source can be improved. Thus, the energy loss of the entire electrical equipment can be reduced to achieve the electric power saving of the electrical equipment. Furthermore, in the electrical equipment according to the present invention, the fuel cell system may be installed in the casing to integrate the fuel cell system with the casing.

### BRIEF DESCRIPTION OF THE DRAWINGS

FIG. 1 is a block diagram showing electrical equipment according to an embodiment of the present invention.

FIG. 2 is a view for explaining a state in which a flow path 20A in the embodiment is heated.

FIG. 3 is a view for explaining a state in which heat is dissipated from a flow path 20E in the embodiment.

### BEST MODE FOR CARRYING OUT THE INVENTION

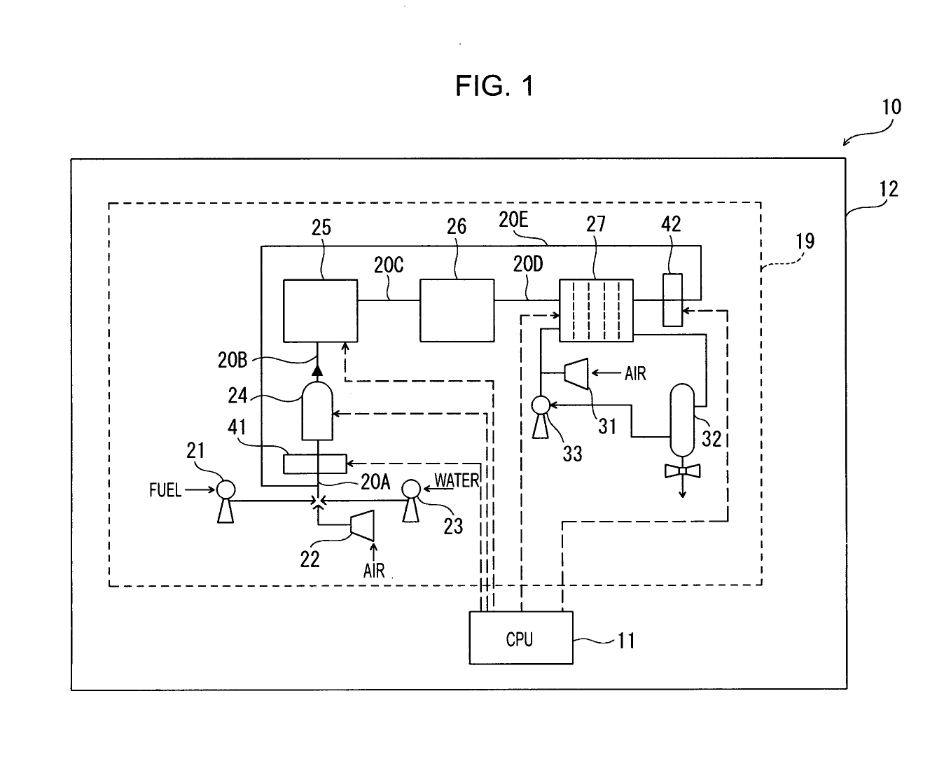

A fuel cell system, a method of power generation of the fuel cell system, and electrical equipment according to the present invention will now be described with reference to FIGS. 1 to 3. The fuel cell system, the method of power generation of the fuel cell system, and the electrical equipment according to this embodiment are exemplifications. It should be understood that the fuel cell system, the method of power generation of the fuel cell system, and the electrical equipment can be appropriately modified within the scope of the present invention.

FIG. 1 is a block diagram showing a computer 10 according to the present embodiment. The computer 10 includes a central processing unit (CPU) 11, a fuel cell system 19 supplying an electric power for driving the CPU 11, and a casing 12 for housing these components. The computer 10 and the fuel cell system 19 are housed in the casing 12 to be integrated.

The CPU 11 is a semiconductor device that is operated upon receiving a supply of electric power from the fuel cell system 19. During the operation, the CPU 11 generates an energy loss to generate heat. That is, when the CPU 11 operates in the computer 10, the CPU 11 generates heat causing the increase in the temperature in the computer 10. Thus, the CPU 11 functions as a source of heat generation. The source of heat generation is not limited to a semiconductor device such as the CPU 11. For example, the source of heat generation may be various electronic components constituting a data processing system for computer graphics, which processes a large amount of data. Alternatively, the source of heat generation may be a north bridge that controls the CPU 11, a memory, or a graphics card. In other words, the source of heat generation is not limited to the electronic components described above so long as the source of heat generation generates heat when installed in electrical equipment such as the computer 10 and is driven. However, a source of heat generation having a large heating value is particularly preferable. In this embodiment, sources of heat generation other than the CPU 11 are not shown in the figure. In addition, although only a single source of heat generation such as the CPU 11 is shown in the figure, a plurality of various electronic components serving as the source of heat generation may be disposed in the computer 10. Furthermore, the source of heat generation may be different kinds of electronic components.

The fuel cell system 19, which is an electric power source that supplies the CPU 11 with an electric power for driving, includes a fuel pump 21, air blowers 22 and 31, water pumps 23 and 33, a carburetor 24, a reformer 25, a carbon monoxide-removing device 26, a fuel cell 27, a steam separator 32, and heat sinks 41 and 42. The fuel pump 21, the air blowers 22 and 31, and the water pumps 23 and 31 may be installed in the computer 10 as in this embodiment or may be disposed outside of the computer 10. When the fuel pump 21, the air blowers 22 and 31, and the water pumps 23 and 33 that are installed in the computer 10 are sufficiently small and has a sufficiently light weight, the portability of the computer 10 is not impaired.

The fuel pump 21 supplies the carburetor 24 with a fuel. A hydrocarbon such as methanol can be used for the fuel. Hydrogen is produced through the carburetor 24, the reformer 25, and the carbon monoxide-removing device 26. This hydrogen is supplied to the fuel cell 27 to perform a power generation. The fuel supplied from the fuel pump 21, water supplied from the water pump 23, and air supplied from the air blower 22 are supplied to the carburetor 24 through a flow path 20A. Although the flow path 20A is shown as a single flow path in the figure, the flow path may include separate flow paths for the fuel, the water, and the air.

The heat sink 41 heats or keeps warm the fuel, the water, and the air, with the flow path 20A therebetween, so that the fuel, the water, and the air are kept at a predetermined temperature. In order to produce hydrogen by reacting the fuel and the water in the reformer 25, the temperatures of the fuel gas and water vapor must be maintained at, for example, about 250° C. to about 300° C. The heat sink 41 supplies the fuel, the water, and the air with heat received from the CPU 11 in order to maintain or increase the temperature of the fuel, the water, and the air that are supplied to the carburetor 24.

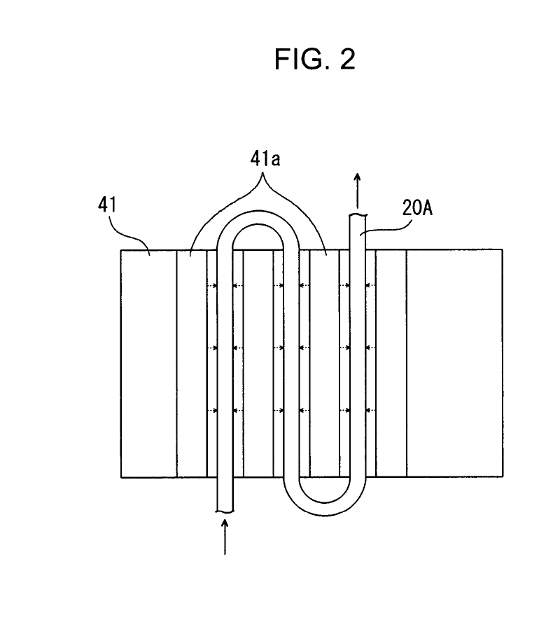

FIG. 2 is a view for explaining a state in which heat is transferred from the heat sink 41 to the flow path 20A. The heat sink 41 includes a plurality of ribs 41a that are substantially parallel in the longitudinal direction. The flow path 20A can be disposed so as to snake between these ribs 41a. The fuel flowing through the flow path 20A from the inlet of the heat sink 41 receives heat from the ribs 41a and is heated or kept warm while flowing in a snaking manner between the ribs 41a provided on the heat sink 41. The fuel is sent to the carburetor 24 from the outlet side of the heat sink 41 through the flow path 20A. In other words, the flow path 20A receives heat from the CPU 11 through the heat sink 41 to function as temperature-controlling means for controlling the temperature of a fluid flowing through the flow path 20A. Such temperature-controlling means forms a heat-transfer path for transferring heat to control the temperature of a fluid. In addition, the temperature-controlling means can control the temperature of the fuel cell system 19 through this fluid. The flow path 20A is not limited to the above-described structure. The flow path 20A may be formed inside the heat sink 41 so as to have a structure in which the flow path 20A is integrated inside the heat sink 41.

Since the ribs 41a provided on the heat sink 41 can be disposed adjacent to the flow path 20A, the area where the ribs 41a and the flow path 20A are adjacent to each other can be increased. Consequently, heat can be efficiently transferred from the heat sink 41 to the flow path 20A. Accordingly, the thermal energy of the CPU 11, which is hitherto exhausted and is not used, can be utilized for adjusting the temperature of the fuel without separately driving a heater for controlling the temperature. Furthermore, the temperature of the fuel flowing through the flow path 20A is increased, thereby the output of a heater provided on the carburetor 24 can be reduced and the quantity of heat supplied from the carburetor 24 to the fuel in order to vaporize the fuel can also be reduced. The quantity of heat supplied to the flow path 20A can be adjusted by changing the number of the ribs 41a provided on the heat sink 41.

The carburetor 24 heats the fuel and water to vaporize and send the resultant fuel gas, water vapor, and air to the reformer 25. Here, the heat generated from a source of heat generation such as the CPU 11 is not exhausted to the outside of the computer 10 but is supplied from the CPU 11 to the carburetor 24 in order to heat the fuel gas, the water vapor, and the air. In order to transfer the heat from the source of heat generation such as the CPU 11 to the carburetor 24, the CPU 11 may be directly brought into contact with the carburetor 24. Alternatively, the CPU 11 may be disposed adjacent to the carburetor 24 so that the heat transfer can be efficiently performed. That is, a heat-transfer path may be formed by directly bringing the CPU 11 into contact with the carburetor 24. Alternatively, the CPU 11 is disposed adjacent to the carburetor 24, and a space formed between the CPU 11 and the carburetor 24 may be used as a heat-transfer path. Thus, the heat transfer can be performed. In addition, the quantity of heat for the heat transfer may be controlled by changing the layout of the CPU 11 and the carburetor 24 to adjust the temperature of the carburetor 24. Furthermore, the amount of the heat transfer may be controlled by monitoring the temperature of the carburetor 24.

In the reformer 25, the water and the fuel supplied through a flow path 20B are reacted to produce hydrogen. When the hydrogen is produced, it is important that the water vapor and the fuel gas are maintained at a temperature of about 250° C. to about 300° C. as described above. Therefore, the heat is supplied from the CPU 11 to the reformer 25 and this heat can be utilized for controlling the temperature of the water vapor and the fuel gas. In order to transfer the heat from the source of heat generation such as the CPU 11 to the reformer 25, the CPU 11 may be directly brought into contact with the reformer 25. Alternatively, the CPU 11 may be disposed adjacent to the reformer 25 so that the heat transfer can be efficiently performed. That is, a heat-transfer path may be formed by directly bringing the CPU 11 into contact with the reformer 25. Alternatively, the CPU 11 is disposed adjacent to the reformer 25, and a space formed between the CPU 11 and the reformer 25 may be used as a heat-transfer path. Thus, the heat transfer can be performed.

In addition, the quantity of heat for the heat transfer may be controlled by changing the layout of the CPU 11 and the reformer 25 to adjust the temperature of the reformer 25. Furthermore, the amount of the heat transfer may be controlled by monitoring the temperature of the reformer 25. In other words, the temperatures of the fuel and the water can be controlled without separately driving a heater for controlling the temperature. The thermal energy of the CPU 11, which is hitherto exhausted and is not used, can be reused. The reformer 25 sends hydrogen produced in the reformer 25 and a carbon monoxide-removing device 26 generated during producing the hydrogen to the carbon monoxide-removing device 26 through a flow path 20C. The carbon monoxide-removing device 26 removes carbon monoxide that is generated together with the hydrogen produced in the reformer 25, and supplies the fuel cell 27 with the hydrogen through a flow path 20D. In addition, the flow path 20D may pass through a heat sink receiving heat from the CPU 11 so as to heat the hydrogen to a predetermined temperature. Subsequently, the hydrogen may be supplied to the fuel cell 27.

The fuel cell 27 generates electric power by reacting air supplied from the air blower 31 with the hydrogen supplied through the flow path 20D. When a power generation body provided in the fuel cell 27 includes a conductive film such as a solid polymer conductive film, the power generation is performed while the conductive film is maintained in an adequate moisture-absorbing state with water supplied from the water pump 33. In order to improve the power generation efficiency of the fuel cell 27, it is also important that the temperature of the fuel cell 27 is controlled so that the temperature of the power generation body is adjusted to a temperature at which the hydrogen is easily reacted with oxygen contained in the air. Therefore, for example, a heat sink may be disposed on a flow path for supplying air from the air blower 31 to the fuel cell 27. Consequently, heat can be transferred from the CPU 11 to the flow path of the air with this heat sink. Thus, the heat is transferred to the fuel cell 27 with the air flowing in the flow path to control the temperature of the fuel cell 27.

A source of heat generation such as the CPU 11 may be disposed so as to be directly in contact with the fuel cell 27, thereby transferring heat from the CPU 11 to the fuel cell 27 directly. Alternatively, the fuel cell 27 may be disposed adjacent to the CPU 11 to control the quantity of heat to be transferred. Thus, the temperature of the fuel cell 27 can be controlled. In other words, the layout of the CPU 11 serving as a source of heat generation and the fuel cell 27, and the transfer of heat generated from the CPU 11 to the fuel cell 27 by the air supplied to the fuel cell 27 can improve the power generation efficiency. Consequently, the heat from the CPU 11, which is hitherto exhausted, is effectively utilized to improve the power generation efficiency of the fuel cell 27. Furthermore, a cooling fan, which is hitherto provided in order to exhaust the heat generated from the CPU 11, need not be driven. Therefore, an electric power generated by the fuel cell 27 can be efficiently used as an electric power for driving the computer 10. Furthermore, an energy that is wasted by exhausting to the outside of the computer 10 can be effectively utilized. The computer 10 may include or may not include a cooling unit such as a cooling fan. When the computer 10 includes a cooling unit, the driving or the non-driving of the cooling unit may be controlled. When the fuel cell 27 includes a power generation body having a conductive film, the temperature of this power generation body can be controlled by adjusting the temperature of the fuel cell 27. Thus, the moisture-absorbing state of the power generation body can also be controlled.

An unreacted fuel gas generated during the power generation in the fuel cell 27 is again sent to the carburetor 24 through a flow path 20E. The flow path 20E receives heat from the CPU 11 though the heat sink 42, and the unreacted fuel gas is sent to the carburetor 24 while the temperature of the unreacted fuel gas is controlled. When the heat is transferred from the CPU 11 to the heat sink 42, the heat sink 42 controls the temperature of the unreacted fuel gas. In addition, when the heat is not transferred from the CPU 11 to the heat sink 42, the heat sink 42 can function as a cooling unit for cooling the unreacted fuel gas or the air discharged from the fuel cell 27. Also, when the heat sink 42 includes a cooling unit, the optimum temperature control of the above-described unreacted fuel can be performed.

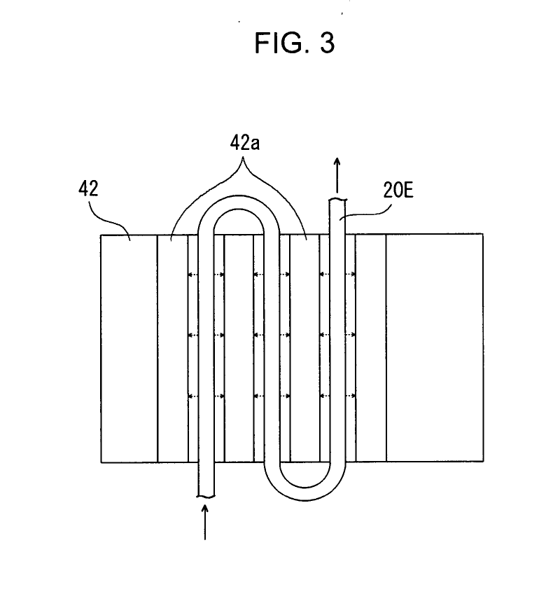

FIG. 3 is a view for explaining a state in which heat is dissipated from the flow path 20E through the heat sink 42. The heat sink 42 includes a plurality of ribs 42a that are substantially parallel in the longitudinal direction. The flow path 20E can be disposed so as to snake between these ribs 42a. The unreacted fuel gas flowing through the flow path 20E from the inlet of the heat sink 42 is cooled by dissipating heat from the ribs 42a while flowing in a snaking manner between the ribs 42a provided on the heat sink 42. The unreacted fuel gas is sent to the carburetor 24 from the outlet side of the heat sink 42 through the flow path 20E. Thus, the ribs 42a provided on the heat sink 42 can be disposed adjacent to the flow path 20E. In addition, the area where the ribs 42a and the flow path 20E are adjacent to each other can be increased. Consequently, heat can be efficiently dissipated from the heat sink 42 to the flow path 20E. Therefore, the flow path 20E is heat-exhausting means for exhausting heat from the unreacted fuel gas flowing through the flow path 20E. The flow path 20E forms a heat-exhausting path that exhausts heat from the unreacted fuel gas. The accumulation of heat in the fuel cell system 19 caused by a reaction for the power generation can be suppressed. Thus, the increase in the temperature of the fuel cell 27 can be suppressed. By suppressing the increase in the temperature of the fuel cell 27, the moisture content of the conductive film constituting the power generation body provided in the fuel cell 27 can be maintained in a preferable state for the reaction for the power generation.

Furthermore, by dissipating the heat through the fuel, the fuel cell 27 can be controlled so as to have a temperature suitable for the reaction for the power generation. As a result, the power generation efficiency can be improved. In addition, a flow path for the heat dissipation is not limited to the flow path 20E. Heat may be dissipated from the flow paths 20A to 20D to control the temperatures of fluids flowing through these flow paths. Thus, the temperature of the fuel cell 27 may be controlled. Accordingly, the temperature of the fuel cell system 19 can be controlled by adjusting the temperatures of the fuel gas flowing through the fuel cell system 19, the hydrogen produced from the fuel, and the air. Consequently, the reaction efficiency of producing hydrogen from the fuel gas can be increased, and in addition, the efficiency of the reaction for the power generation performed in the fuel cell 27 can be increased. Furthermore, the heat generated from a source of heat generation such as the CPU 11 is not exhausted but is utilized for the temperature control of the fuel cell system. Therefore, the electric power generated by the fuel cell 27 is not consumed by a cooling unit, which is separately driven in order to exhaust the heat from the CPU 11. The electric power consumed in peripheral devices that are used for the power generation by the fuel cell system 19 can be reduced. Accordingly, the electric power generated by the fuel cell 27 can be effectively used in electrical equipment such as the computer 10 and the power generation efficiency of the fuel cell 27 can be improved.

The moisture contained in the air discharged from the fuel cell 27 is separated with the steam separator 32 and is then sent to the water pump 33. The moisture is reused as moisture for maintaining the moisture content of the fuel cell 27. The air that hardly contains oxygen is discharged from the steam separator 32 to the outside.

As described above, according to the fuel cell system 19 and electrical equipment such as the computer 10 according to this embodiment, heat generated from a source of heat generation such as the CPU 11 disposed in the computer 10 can be utilized for heating or keeping warm the fuel, water, and air used in the fuel cell system 19. Thus, hydrogen can be produced from the fuel without providing a separate heater for a temperature control. Furthermore, since the temperature of the fuel cell 27 can be controlled, the fuel cell 27 can be maintained at a temperature suitable for the power generation. Hitherto, the heat generated from a source of heat generation such as the CPU 11 causes an excessive increase in the temperature of the fuel cell system 19. However, by utilizing this heat to control the temperature of the fuel cell fuel cell system 19, a power generation can be smoothly performed without driving a separate cooling unit for the fuel cell 27. Consequently, waste energy, which is hitherto exhausted in electrical equipment such as the computer 10, can be reduced and the power generation efficiency of the fuel cell 27 can also be improved.

In the description of this embodiment, the computer 10 is used as an example of electrical equipment. However, the electrical equipment according to the present invention is not limited to a computer and may be, for example, projection equipment such as a projector. The projector includes a lamp as a light source and the temperature of the lamp may become high during lighting. The heat generated from the lamp is used for controlling the temperature of a fuel cell system. Consequently, as in the case with the computer 10, waste energy, which is hitherto exhausted as a thermal energy, can be effectively utilized. In addition, when the projector is driven with a fuel cell as an electric power source, the power generation efficiency of the fuel cell can be improved.

As described above, according to the fuel cell system, a method of power generation of the fuel cell system, and electrical equipment of the present invention, heat generated from a source of heat generation disposed in electrical equipment can be utilized for heating or keeping warm a fuel. Therefore, even when a hydrocarbon such as methanol is used as the fuel, hydrogen, which is directly used for the reaction for the power generation, can be efficiently produced. In addition, waste energy, which is hitherto exhausted and is considered as an energy loss that does not contribute to the driving of electrical equipment, can be effectively utilized.

Furthermore, according to the fuel cell system, a method of power generation of the fuel cell system, and electrical equipment of the present invention, heat generated from a source of heat generation disposed in electrical equipment can be utilized for controlling the temperatures of a fuel cell and other peripheral devices constituting a fuel cell system. The fuel cell system can be controlled so as to have a temperature suitable for the power generation without providing a separate heater for a temperature control. In addition, the fuel can be cooled through a flow path of the fuel to exhaust the excessive heat to the outside. Thus, the heating, the keeping warm, and the cooling of the fuel cell system can be combined, thereby maintaining the fuel cell system at a temperature suitable for the power generation and improving the power generation efficiency.

Furthermore, according to the fuel cell system, a method of power generation of the fuel cell system, and electrical equipment of the present invention, a cooling unit for cooling a source of heat generation is not necessary. Consequently, the electric power that is hitherto consumed for driving the cooling unit can be reduced, and the electric power generated by the fuel cell system can be efficiently utilized as an electric power for driving the electrical equipment.

1. A fuel cell system comprising:
a fuel cell; and
temperature-controlling means that controls the temperature of the fuel cell by performing a heat transfer from a source of heat generation provided in electrical equipment to the fuel cell.

2. The fuel cell system according to claim 1, wherein the temperature-controlling means is a heat-transfer path that transfers a required quantity of heat.

3. The fuel cell system according to claim 2, wherein the heat-transfer path is a flow path of a fluid that mediates the heat transfer.

4. The fuel cell system according to claim 3, wherein the flow path is disposed so as to be adjacent to a heat sink that receives heat from the source of heat generation.

5. The fuel cell system according to claim 3, wherein the fluid is at least one of a fuel fluid and a fluid for oxidation used for a power generation.

6. The fuel cell system according to claim 5, wherein the temperature of the at least one of the fuel fluid and the fluid for oxidation is controlled in the flow path.

7. The fuel cell system according to claim 1, further comprising a reformer, wherein the temperature-controlling means controls the temperature of the reformer by the heat transfer.

8. The fuel cell system according to claim 1, further comprising a carburetor, wherein the temperature-controlling means controls the temperature of the carburetor by the heat transfer.

9. The fuel cell system according to claim 1, further comprising heat-exhausting means that exhausts an excessive quantity of heat transferred to the fuel cell.

10. The fuel cell system according to claim 9, wherein the heat-exhausting means is a heat-exhausting path that exhausts the excessive quantity of heat.

11. The fuel cell system according to claim 10, wherein the heat-exhausting path is a flow path of a fluid that transfers the excessive quantity of heat.

12. The fuel cell system according to claim 11, wherein the flow path is disposed so as to be adjacent to a heat sink provided outside of the fuel cell.

13. A method of power generation of a fuel cell system wherein a heat transfer is performed from a source of heat generation provided in electrical equipment to a fuel cell system including a fuel cell, and the temperature of the fuel cell system is controlled by the heat transfer to perform a power generation.

14. Electrical equipment comprising:
a source of heat generation;
a casing that houses the source of heat generation; and
a fuel cell system including a fuel cell and temperature-controlling means that controls the temperature of the fuel cell by performing a heat transfer from the source of heat generation,
wherein the electrical equipment is driven by an electric power supplied from the fuel cell system.

15. The electrical equipment according to claim 14, wherein the fuel cell system is installed in the casing to integrate the fuel cell system with the casing.
